(19) United States
(12) Patent Application Publication
(10) Pub. No.: US 2004/0022614 A1
(43) Pub. Date: Feb. 5, 2004

(54) Handicapped lift seat for vehicles

(76) Inventor: Larrey Anderson, Twin Falls, ID (US)

Correspondence Address: ROBERT L. SHAVER, DYKAS, SHAVER & NIPPER, LLP, PO BOX 877, BOISE, ID, 83701-0877, US

(21) Appl. No.: 10/209,120

(22) Filed: Jul. 31, 2002

(51) Int. Cl. A61G 3/08

(52) U.S. Cl. 414/540

(57) ABSTRACT

The invention is a handicapped lift seat which replaces a vehicle seat in a vehicle and allows a handicapped person to raise the vehicle seat up, swing it out of the vehicle, and lower it to a position near the ground for easy entry and exit. The handicapped lift seat includes a vehicle seat that is mounted to a seat plate, which is attached to a screw jack assembly. Activation of the electric motor of the screw jack causes the vehicle seat to be raised up and down. Once disengaged from a plate mounted on the vehicle floor, the handicapped lift seat can be swung in or out of the vehicle manually and can be lowered by the motor to a position for easy entry and exit.

### BACKGROUND OF THE INVENTION

1. Field of the Invention

The present invention generally relates to handicapped assistance devices in vehicles, and more particularly relates to vehicle seats which handicapped lift and lower in order to raise a handicapped person in to the vehicle.

2. Background Information

It is a fact of modem life that transportation in a personal vehicle is essential in many localities. Whether this is by car, truck or van, many activities of daily life require transportation by personal automobile. Unfortunately, there is a significant population of people who have difficulty getting into an automobile. This can be due to the fact that they are in a wheelchair and the caretaker must lift them into the seat of an automobile. In other cases, a person can walk with a cane or walker, but has difficulty stepping up to the higher level of an automobile.

In such a case, what is needed is a lifting device which lifts the handicapped person from a fairly low loading position into the vehicle. In such a device, the handicapped person could either be transferred from a wheelchair into the lifting device, or could sit in a chair of the lifting device from his/her position standing on the ground. After loading the handicapped person into the vehicle, a lifting device would then lift them to the height of the automobile, allow them to swing into the automobile, secure the seat in position inside the automobile, and allow the person to either drive the vehicle, or be a passenger in the vehicle. This would be for the benefit of not only the handicapped person, but also of the person assisting or transporting this person.

Ideally, the handicapped lift seat would lower to a position that was approximately equal to the height of a wheelchair. This height would also make it easy for a person who could walk with a cane or walker to sit on the handicapped lift seat when it was in its loading position. The device should then be able to lift a person up to the height of the vehicle floor, allow them to swing into the vehicle and secure the seat within the vehicle for travel. Each of these steps and positions should be effortless for the handicapped person, and result in a smooth transition. The seats should also be able to accommodate handicapped persons of a variety of sizes and weights.

### SUMMARY OF THE INVENTION

These and other objects are accomplished in the handicapped lift seat of the present invention. The handicapped lift seat of the invention starts from an engaged position within the vehicle, in which the seat plate is firmly attached to a base plate. From the engaged position, the jacking means and its motor are activated which causes the seat and the seat plate to be raised vertically away from the base plate on the floor of the vehicle. Raising of the seat plate is stopped when the vehicle seat is in a raised inside position directly above the base plate. From this position, the vehicle is rotated by manual pressure from the user or an assistant, to a raised outside position, which is at the same level as the raised inside position, but is outside of the vehicle. From the raised outside position, the seat plate is lowered to a loading position near the ground surface and outside the vehicle. From this position, a user may enter or exit the vehicle seat. If in a wheelchair, the person moves himself/herself, or is helped to move from the wheelchair seat into the vehicle seat. For a person who walks with a cane or a walker, or who walks on their own, they may sit on the vehicle seat for loading and unloading. In the loading position, the vehicle seat is located at a position which is low enough to the ground that sitting on the vehicle seat is not difficult for a handicapped person. Lifting the user into the vehicle is accomplished by the reverse steps.

The handicapped lift seat of the present invention is a vehicle seat mounted on a lifting arm which swings out of the vehicle, and locks in place in the vehicle for travel. The seat arm raises and lowers a user from the ground into the vehicle by use of a lifting device. The handicapped lift seat of the invention includes a base plate mounted to the floor of a vehicle. The base plate includes a positioner for guiding a seat plate into position when the seat plate is lowered vertically onto the base plate. The positioner would typically be an upraised lateral edge of the base plate, which interacts with a corresponding lateral edge of the seat plate to guide it into position. The handicapped lift seat of the present invention also has a seat plate to which a vehicle seat is attached. The seat plate is configured to interlock with the base plate when it is lowered onto the seat plate. The seat plate is attached to a seat arm. The seat arm is attached to a lifting assembly. The lifting assembly is typically a screw jack mounted inside a shaft. The seat arm is freely rotatable around the shaft so that the handicapped person can easily move or be moved from a position outside of the vehicle to a position inside the vehicle. The shaft is mounted to the floor of the vehicle, and may extend through the floor of the vehicle.

The lifting assembly includes a shaft plate which is configured for connection to the vehicle floor. Attached to the shaft plate is a shaft which contains a jacking means. The jacking means is configured to raise and lower the seat plate by means of a seat arm, which is attached to the jacking means, upon activation of the jacking means. The jacking means has a motor which raises the seat arm and the attached seat and vehicle plates. A motor control is also present for turning the motor on and off and selecting reverse or forward. One or more shaft braces are utilized to strengthen the shaft.

One type of jack that is utilized for the jacking means is a screwjack, which has a threaded rod inside the shaft. As the motor turns the threaded rod of the screw jack, it operates against a fixed nut to cause the vehicle seat to raise and lower.

One feature of the handicapped lift seat is that the shaft plate may include a tube which extends below the floor of the vehicle. The shaft extends to the base of this tube. This extra length of tube at that height allows the seat arm and the vehicle seat attached to it to be lowered to a position closer to the ground for easier entry and exit of the user.

The device typically utilizes an electric screw jack motor located at the top end of the screw jack, but it could also function with a motor at the bottom end of the screw jack.

The positioner of the base plate can include protrusions or perforations which interact with corresponding perforations or protrusions located on the seat plate. These would mesh together so that when the seat plate is mounted on the base plate, the interlocking protrusions and perforations would strengthen the handicapped lift seat against any movement of the seat plate off the base plate. The handicapped lift seat can also include a locking mechanism, which positively locks the base plate to the seat plate, and which may be easily unlocked for moving the vehicle seat out of the vehicle.

The handicapped lift seat is particularly advantageous when used with a quad door pickup. This is a type of pickup which has four doors, in which the two doors on either side come together and lock in place together, without the presence of a doorpost. The absence of the doorpost, and the extra room behind the seat in which the handicapped lift seat is mounted, is useful for the extra clearance which is needed for the handicapped lift seat.

The seat plate may also have a locking plate on the medial edge, which is useful for positioning the seat base against the drive shaft tunnel of the vehicle as the seat base is lowered onto the base plate. The motor control is a handheld device which the user can hold from the seat, to activate the jacking means motor, and to switch it to up or down. This device can also be made as a wireless control unit.

The seat base of the handicapped lift seat includes one or more stiffening braces which adds strength to the weight supporting structure of the lifting assembly.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the invention. Accordingly, the drawings and description of the preferred embodiment are to be regarded as illustrative in nature, and not as restrictive.

### BRIEF DESCRIPTION OF THE DRAWINGS

FIG. 1 is a side view of the handicapped lift seat mounted in a vehicle.

FIG. 2 is a side, partial cross-sectional view of the handicapped lift seat installed in a vehicle.

FIG. 3 is a front view of the handicapped lift seat.

FIG. 4 is a front view of the handicapped lift seat.

FIG. 5 is a side view of the shaft bracket assembly.

FIG. 6 is a top view of the shaft bracket assembly.

FIG. 7 is a front view of the handicapped lift seat in an inside, raised operational position.

FIG. 8 is a front view of the vehicle, with the handicapped lift seat moved to an outside, raised operational position.

FIG. 9 is a front view of the vehicle, showing the handicapped lift seat lowered to the outside, lowered operational position.

FIG. 10 is side cross-sectional view of the screw jack in an extended position.

FIG. 11 is a side cross-sectional view of the screw jack in a lowered position.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

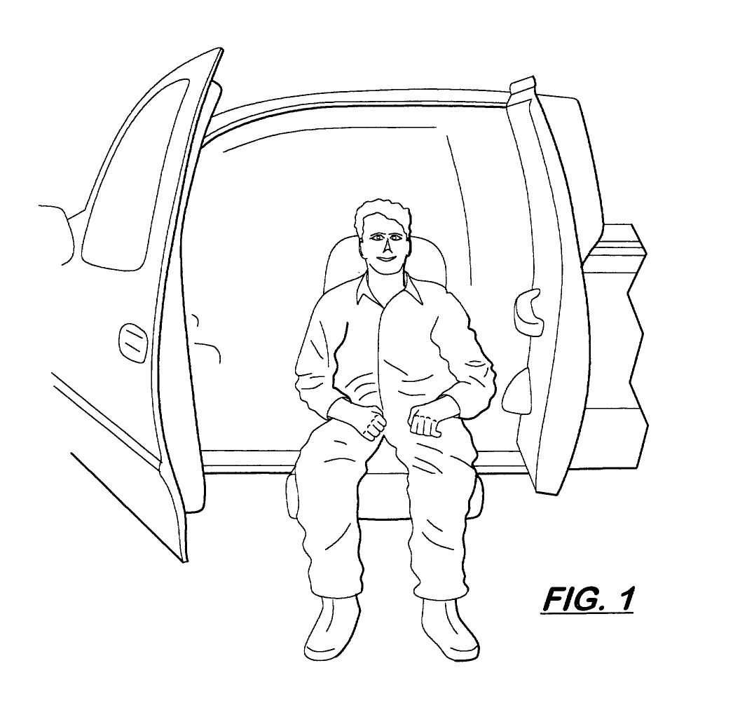

FIG. 1 is a side view of the handicapped lift seat shown with the seat outside the vehicle and ready to lift a user up to the vehicle height and allow the user to swing into position inside the vehicle. Although shown on the driver's side door, the handicapped lift seat of the invention may also be mounted on the passenger side door. FIG. 1 shows a device mounted with a quad door pickup, which has two doors on each side of the vehicle and no doorpost between them. This type of vehicle is advantageous because it allows greater room at the door for the device and for swinging the chair outside of the vehicle. However, the device could be mounted in other types of vehicles including passenger vehicles.

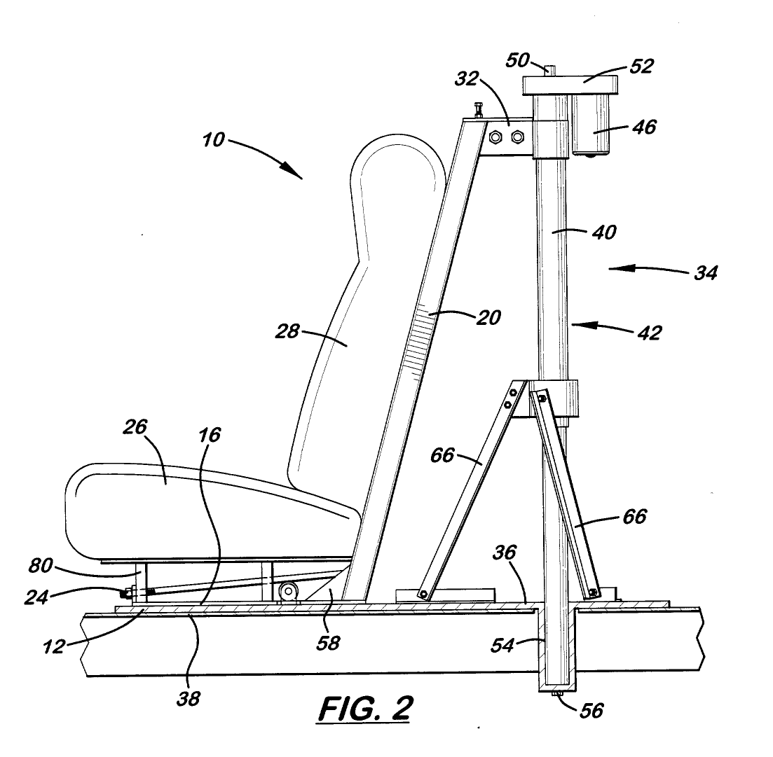

FIG. 2 is a side view of the handicapped lift seat 10 mounted in a vehicle. It is a partial cross section of the vehicle floor, showing part of the device extending through the vehicle floor. The device includes a base plate 12 which is a steel plate attached to the vehicle floor 38. Directly above the base plate 12 is a seat plate 16. In this view, the seat plate 16 is in contact with base plate 12. Various devices (explained below) can be used to form a positive interlocking fit between the base plate 12 and the seat plate 16. The seat plate 16 is attached to a seat arm 20. Where the seat plate 16 is connected to the seat arm 20, a gusset 58 is added for strength. A seat plate-tensioning rod 60 is utilized with a seat bracket 80 with a seat brace-adjusting nut 24, which is used to adjust the tension and angle of the seat plate 16. The seat arm 20 is attached to a shaft 40 by a top lift arm 32. A vehicle seat bottom 26 and a vehicle seat back 28 are attached to the seat plate 16 and the seat arm 20. The view shown in FIG. 2 is of the device in an engaged operational position.

The seat arm 20 is attached to the lifting assembly 34. The lifting assembly 34 includes the shaft 40, a shaft plate 36, and a jacking means 42, which is preferably a screw jack. The screw jack includes a motor 46 and preferably a gear box 52. A manual hex nut 50 is present and allows manual operation of the screw jack. In a preferred embodiment, the lifting assembly 34 includes a shaft tube 54, which penetrates and extends below the vehicle floor 38. In the bottom of the shaft tube 54, a shaft bolt 56 is located that anchors the screw jack 44 in place in the bottom of the shaft tube 54. Mounted in the shaft 40 is a screw nut 62. The screw nut 62 is mounted so that it does not turn, but rather the screw shaft of the screw jack 44 rotates and causes the shaft 40 to move up and down in relation to the screw nut 62. Shaft 40 is enclosed within a shaft bracket 64. The shaft bracket 64 is supported by braces 66, which connect the shaft bracket 64 to the shaft plate 36. The shaft plate 36 is firmly anchored to the vehicle floor 38. Shaft bracket 64 has a nylon bushing (not shown) which allows shaft 40 to extend up and down throughout.

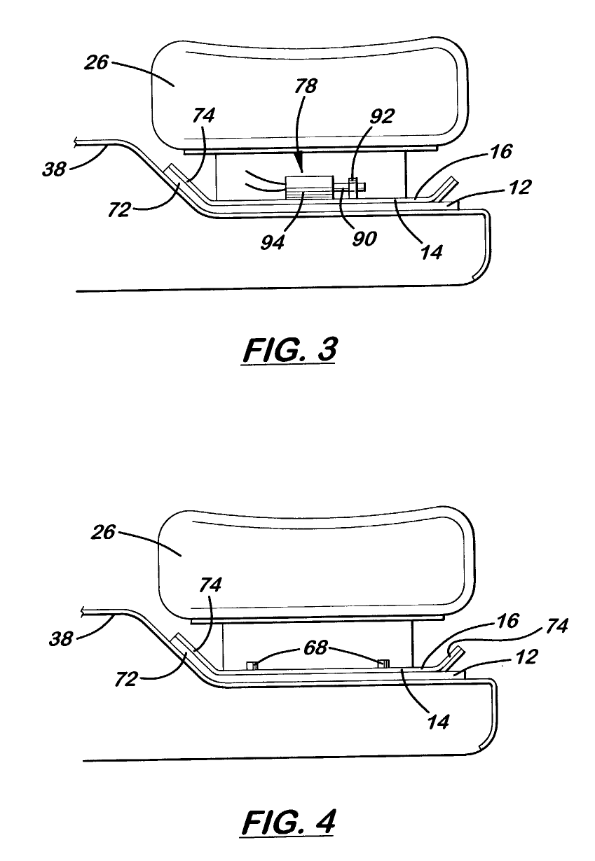

FIG. 3 is a more detailed view of the base plate 12 and the seat plate 16. The base plate 12 is firmly bolted to the vehicle floor 38. The base plate 12 includes a positioner 14. In this case, the positioner 14 is a ridge along the lateral side of the base plate 12. The positioner 14 can take other forms such as one or more protrusions on the base plate 12 which extend through one or more perforations in the seat plate 16. Protrusions 68 represent one type of positioner and would fit through corresponding interlocking perforations 70 formed in the seat plate 16. Obviously, the protrusions could be mounted on the seat plate 16 and extend through perforations on the base plate 12. A lock 78 is present which secures the seat plate 16 to the base plate 12. A solenoid type lock is shown, and other locks and latches known in the industry could also be used.

In FIGS. 3 and 4, show a further structure is provided on the base plate 12, including an angle plate 72, which is attached to the lateral edge of base plate 12 and conforms to the shape of a particular vehicle floor 38. The type of positioner 14 shown in FIG. 3 can be termed a locking plate. Seat plate 16 also includes an angled lip on the medial side, which is called a locking wedge 74. The locking wedge 74 is made to conform to the shape of the vehicle floor 38, as shown in FIGS. 3 and 4. The locking wedge 74 would typically rest against a drive shaft tunnel in the vehicle. In an actual installation, the base plate 12 would be firmly attached to the vehicle floor 38, and the seat plate 16 would be raised and lowered into position in contact with the base plate 12. The positioner 14, in whatever configuration was chosen, would guide the seat plate 16 as it was being lowered into a position in which it is firmly locked with the base plate 12. This could include the use of one or more protrusions 68 and corresponding perforations 70.

An optional feature on the handicapped lift seat 10 is a locking mechanism 78 which positively locks the seat plate 16 to the base plate 12. This can take a number of forms, one of which is shown in FIG. 3. This is a solenoid 94 which pushes a locking pin 90 into a locking bracket 92.

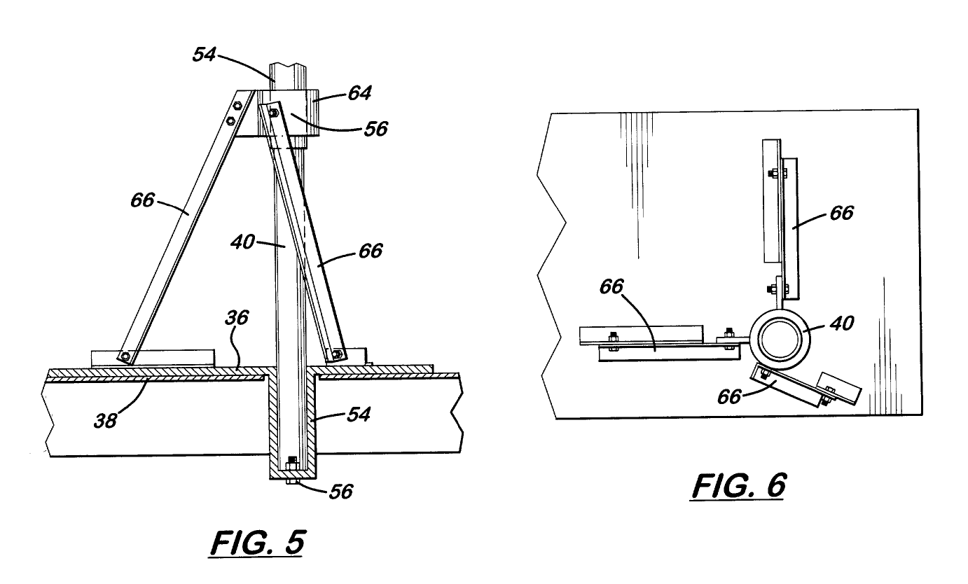

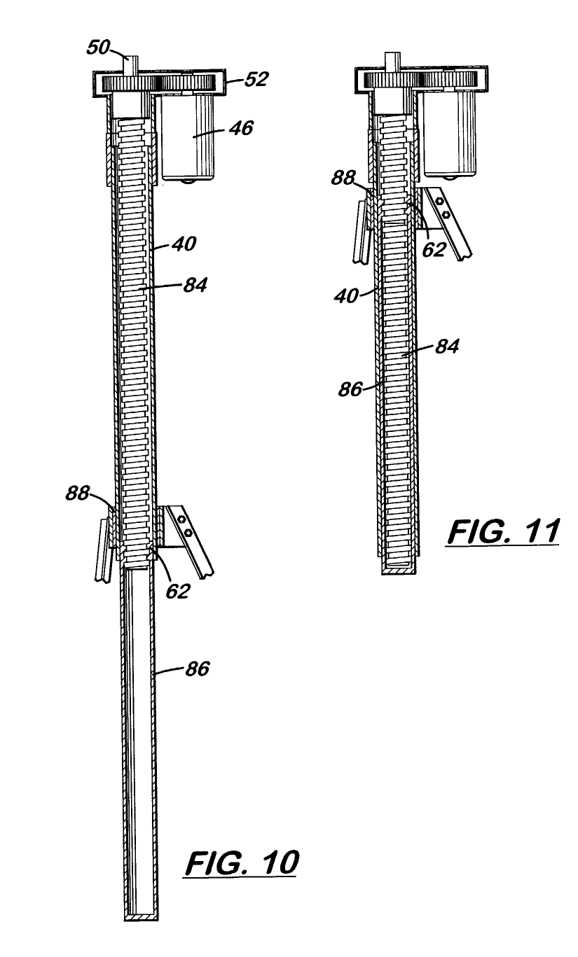

FIG. 5 shows a side view of the shaft bracket 64 and the braces 66. They are anchored to a shaft plate 36. FIG. 5 shows a top view of the same structure. In FIG. 4, the shaft tube 54 is clearly shown, with the shaft bolt 56 to which the shaft 40 is anchored. The braces 66 are configured to support the shaft 40, and the weight placed on it by a user when the device is in operation. The shaft bracket 64 includes a bushing 88, shown in FIGS. 10 and 11, through which the shaft 40 travels.

In operation, the device of the invention has four operational positions. The engaged position is shown in FIG. 2. In this position, the seat plate 16 is firmly in contact with the base plate 12. The seat plate 16 is typically pressed into contact with the base plate 12 by the screw jack and the motor. In case of motor failure, a manual hex nut 50 is provided so that the seat can be manually lowered and raised without use of the motor. In the engaged position shown in FIG. 2, the seat plate 16 may be engaged with the base plate 12 by force applied from the lifting device, and may be further held in place by other positioning devices such as a lock 78, or by the protrusions 68 and corresponding perforations 70 shown in FIG. 3. Although FIG. 2 shows the motor 46 being located at the top of the shaft 40, it can also be positioned at the bottom end of the shaft.

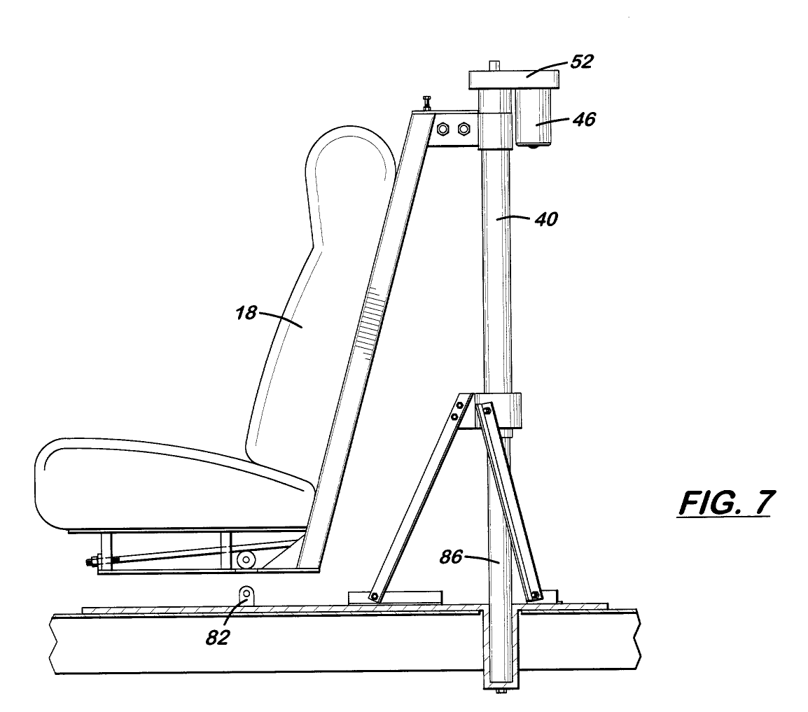

FIG. 7 shows a second operational position of the device. This position is the raised inside position. In this position, the screw jack 44 has raised the seat plate with its attached vehicle seat to a position directly above the base plate 12. At this point, the two plates are not touching, and the handicapped lift seat 10 is free to swing out of the vehicle by manual pressure.

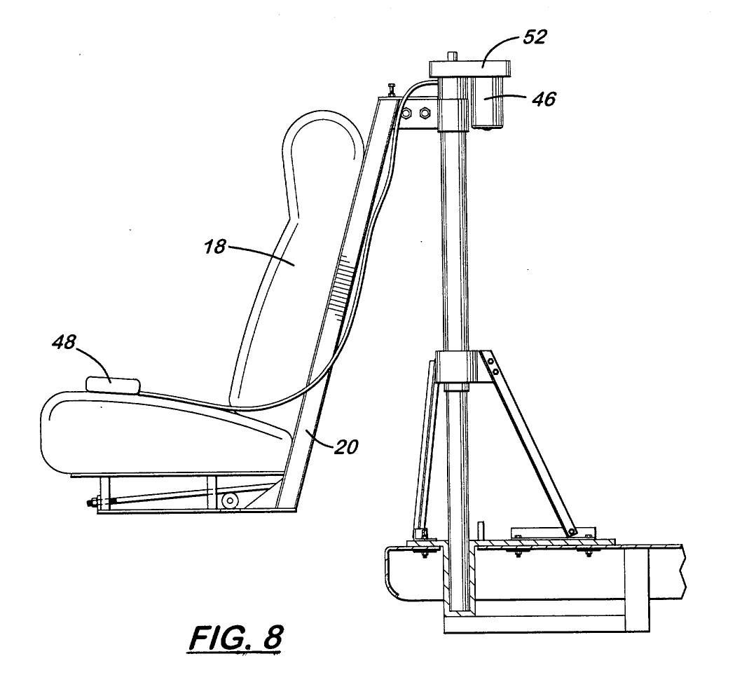

The third operational position is shown in FIG. 8, and that is the “raised outside position.” In this position, the handicapped lift seat 10 is at the same level as shown in FIG. 6, however it has been swung to a position outside the vehicle and facing away from the door of the vehicle. Also shown in FIG. 8 is a motor control 48, which is typically a wired control to the motor. A wireless control 48 is also possible, as shown in FIG. 4.

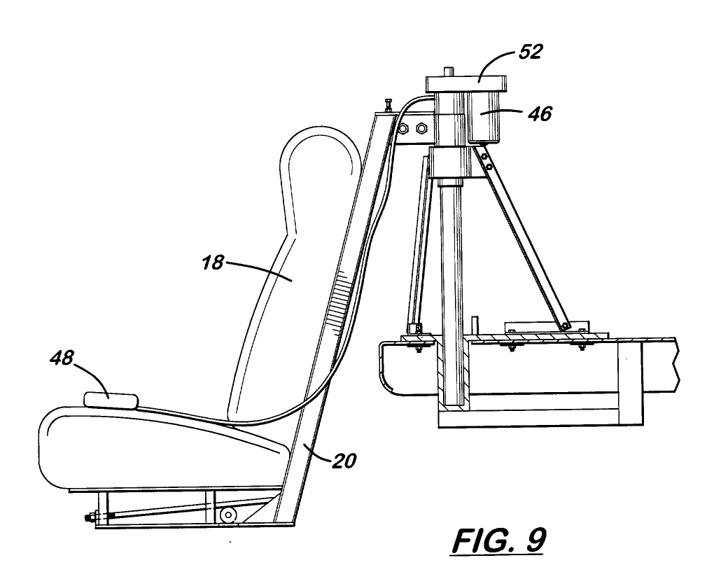

FIG. 9 shows the fourth operational position of the device, which is a loading position. In this position, the vehicle seat is facing away from the open door of the vehicle, and the vehicle seat is lowered to a position close to the ground, providing easy access for exit and entry of a user.

FIGS. 10 and 11 are cross-sectional views of the shaft 40 and the screw jack 44. The screw jack 44 includes a screw shaft 84, a gear box 52, the motor 46, the screw nut 62, and a lower shaft 86. FIG. 10 shows the jack in an extended position. FIG. 11 shows the shaft in a lowered position. In each view, a manual hex nut 50 is located on top of the device, which allows manual lowering and raising of the seat. The motor 46 stays adjacent the seat arm 20, and moves up and down with the seat arm 20 and the attached vehicle seat 18, as shown in FIGS. 10 and 11.

Although the specific configuration of the motor screw jack and braces would vary depending upon the specific installation and the projected weight of the user, certain configurations have proven to be satisfactory. One configuration which has been proven to be satisfactory is the use of a DC electric motor, with a rating of 20 amps, with the capacity to lift 2500 pounds. This is a ball screw type screw jack. Used with this screw jack is a screw shaft of 2.25 inches in diameter. This has proven sufficient to lift a load including a user weighing 300 pounds. The base plate 12 is typically made of 0.25 inches thick steel. The seat plate 16 is made of 0.25 inches thick steel. The shaft plate 36 is preferably 19 inches by 17 inches, and made of 0.25 inch thick steel. The braces 66 are made of steel and join on the shaft bracket, which is located typically 18 inches above the vehicle floor.

While there is shown and described the present preferred embodiment of the invention, it is to be distinctly understood that this invention is not limited thereto but may be variously embodied to practice within the scope of the following claims.

From the foregoing description, it will be apparent that various changes may be made without departing from the spirit and scope of the invention as defined by the following claims.

I claim:

1. A handicapped lift seat for vehicles, comprising:
a base plate mounted to a floor of said vehicle, which includes a positioner, for guiding a seat plate into position when said seat plate is lowered vertically onto said base plate;
said seat plate for attachment of a vehicle seat and configured for interlocking relationship with said locking plate and said positioner;
a seat arm, to which said seat plate and vehicle seat is attached, and which attaches to a lifting assembly in a freely rotatable linkage;
said lifting assembly comprised of a shaft plate configured for connection with said vehicle floor, said shaft plate connected to a shaft containing a jacking means configured to raise and lower said seat plate upon activation of said jacking means, a jacking means motor, for powering said jacking means and thereby lifting and raising of said seat arm, a motor control for activating and deactivating said jacking means motor, and one or more shaft braces for strengthening said shaft;
wherein;
said seat plate is configured for vertical elevation from an engaged position with said base plate by said jacking means and jacking means motor, into a raised inside position directly above said base plate, from which position said seat plate is configured for manual rotation with no contact between said base plate and said seat plate to a raised outside position at the same level and outside said vehicle, from which position said seat plate is configured for lowering to a loading position near a ground surface and outside said vehicle, from which position a user may enter or exit said vehicle seat.

2. The handicapped lift seat for vehicles of claim 1 in which said jacking means is a screw jack.

3. The handicapped lift seat for vehicles of claim 2 in which said screw shaft is a ball bearing type screw jack.

4. The handicapped lift seat for vehicles of claim 2 in which said screw shaft and said screw jack extends through a floor of said vehicle.

5. The handicapped lift seat for vehicles of claim 2 in which said screw jack motor is located on a top end of said screw jack.

6. The handicapped lift seat for vehicles of claim 1 in which said positioner is a locking wedge on a lateral edge of said base plate which interacts with a lateral edge of said seat plate to position said seat plate on said base plate.

7. The handicapped lift seat for vehicles of claim 1 in which said positioner of said seat plate interacts with said seat plate one or more protrusions located on either said base plate or said seat plate, which interact with corresponding openings on either of said base plate or said seat plate.

8. The handicapped lift seat for vehicles of claim 1 which further includes a locking mechanism and locking release for positively locking said base plate to said seat plate.

9. The handicapped lift seat for vehicles of claim 1 in which said handicapped lift seat is configured for installation in a quad door pickup.

10. The handicapped lift seat for vehicles of claim 1 in which seat base further includes a locking plate on a medial edge of said seat base, for positioning said seat base against a drive shaft tunnel of said vehicle when said seat base and attached vehicle seat is lowered onto said base plate.

11. The handicapped lift seat for vehicles of claim 1 in which said motor control is a control unit control unit and a wiring harness.

12. The handicapped lift seat for vehicles of claim 1 in which said motor control is a wireless control unit

13. The handicapped lift seat for vehicles of claim 1 in which seat base has a stiffening brace.

14. A handicapped lift seat for quad door pickups, comprising:
a base plate mounted to a floor of said vehicle, which includes a locking wedge on a lateral edge of said base plate which interacts with a lateral edge of said seat plate to position said seat plate on said base plate, for guiding a seat plate into position when said seat plate is lowered vertically onto said base plate;
said seat plate for attachment of a vehicle seat and configured for interlocking relationship with said locking plate and said positioning lip, which further includes a locking plate on a medial edge of said seat base, for positioning said seat base against a drive shaft tunnel of said vehicle when said seat base and attached vehicle seat is lowered onto said base plate;
a seat arm, to which said seat plate and vehicle seat is attached, and which attaches to a lifting assembly in a freely rotatable linkage;
said lifting assembly comprised of a shaft plate configured for connection with said vehicle floor, said shaft plate connected to a screw shaft containing a screw jack configured to raise and lower said seat plate upon rotation of said screw jack, with said screw shaft and said screw jack extending through a floor of said vehicle, a screw jack motor located on a top end of said screw jack, for rotation of said screw jack and thereby lifting and raising of said seat arm, a motor control for activating and deactivating said screw shaft motor, and one or more shaft braces for strengthening said screw shaft;
wherein;
said seat plate is configured for vertical elevation from an engaged position with said base plate by said screw jack and screw jack motor, into a raised inside position directly above said base plate, from which position said seat plate is configured for manual rotation with no contact between said base plate and said seat plate to a raised outside position at the same level and outside said vehicle, from which position said seat plate is configured for lowering to a loading position near a ground surface and outside said vehicle, from which position a user may enter or exit said vehicle seat.

15. The handicapped lift seat for vehicles of claim 1 in which said positioner of said seat plate interacts with said seat plate one or more protrusions located on either said base plate or said seat plate, which interact with corresponding openings on either of said base plate or said seat plate.

16. The handicapped lift seat for vehicles of claim 1 which further includes a locking mechanism and locking release for positively locking said base plate to said seat plate.

17. The handicapped lift seat for vehicles of claim 1 in which said screw shaft is a ball bearing type screw jack.

18. The handicapped lift seat for vehicles of claim 1 in which seat base further includes a positioning lip on a medial edge of said seat base, for positioning said seat base against a drive shaft tunnel of said vehicle when said seat base and attached vehicle seat is lowered onto said base plate.

19. The handicapped lift seat for vehicles of claim 1 in which said motor control is a control unit control unit and a wiring harness.
